(19) United States
(12) Patent Application Publication
(10) Pub. No.: US 2007/0232753 A1
(43) Pub. Date: Oct. 4, 2007

(54) POLYMER POWDER, PROCESS FOR PRODUCTION OF AND USE OF THIS POWDER, AND RESULTANT SHAPED ARTICLES

(75) Inventors: Sylvia MONSHEIMER, Haltern am See (DE); Hajime Komada, Himeji (JP); Hideki Matsui, Himeji (JP); Yoshiki Nakaie, Himeji (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA GmbH, Duesseldorf (DE)

(21) Appl. No.: 11/694,129

(22) Filed: Mar. 30, 2007

(30) Foreign Application Priority Data
Apr. 1, 2006 (DE) 10 2006 015 791.5

(51) Int. Cl. C08L 61/00; C08L 77/00

(52) U.S. Cl. 525/153; 525/178; 525/165

(57) ABSTRACT

A process for production of a powder suitable for use in a process for the layer-by-layer moldless production of a three-dimensional shaped article, in which regions of the respective powder layer are selectively melted via input of electromagnetic energy, comprising mixing of a polymer or copolymer with at least one water-soluble polymeric polyol, the dissolution of the mixture in water to form a dispersion, the isolation of the polymer particles or copolymer particles from the dispersion, and the washing and drying of the isolated polymer particles or isolated copolymer particles; a powder which comprises a polymer powder or copolymer powder with from 0.001% by weight to 5% by weight content of at least one polymeric polyol, the polymeric polyol having been selected from the group consisting of polyethylene glycols and polyvinyl alcohols; the powder formed from the process; method of using the powder; and a shaped article formed from the powder.

### BACKGROUND OF THE INVENTION

1. Field of the Invention

Rapid production of prototypes is a task often encountered in very recent times. Particularly suitable processes are those whose operation is based on pulverulent materials and which produce the desired structures layer-by-layer via selective melting and hardening. Support structures for overhangs and undercuts can be avoided in these processes, because the powder bed surrounding the molten regions provides adequate support. Nor is there any need for subsequent operations to remove supports. These processes are also suitable for short-run production.

The invention relates to the use of a polymer powder, produced from a dispersion, in shaping processes, and also to shaped articles produced via a layer-by-layer process in which regions of a powder layer are selectively melted, using this powder. After cooling and hardening of the regions previously melted layer-by-layer, the shaped article can be removed from the powder bed.

Selectivity of these layer-by-layer processes can by way of example be achieved by way of application of susceptors, of absorbers, or of inhibitors, or via masks, or by way of focused introduction of energy, for example via a laser beam, or by way of glass fibers, or via selective application of the powder. Energy input is achieved by way of electromagnetic radiation.

A process with particularly good suitability for the purposes of rapid prototyping is selective laser sintering. In this process, plastics powders are selectively and briefly irradiated with a laser beam in a chamber, whereupon the powder particles impacted by the laser beam melt. The molten particles coalesce and rapidly solidify again to give a solid mass. This process can give simple and rapid production of three-dimensional articles via repeated irradiation of a succession of freshly applied layers.

2. Description of the Background

The process of laser sintering (rapid prototyping) for production of shaped articles from pulverulent polymers is described in detail in patent specifications U.S. Pat. No. 6,136,948 and WO 96/06881 (both DTM Corporation). A wide variety of polymers and of copolymers is described for this application, examples being polyacetate, polypropylene, polyethylene, ionomers, and polyamide.

Other processes with good suitability are the SIB process as described in WO 01/38061, or a process as described in EP 1 015 214. Both processes operate with full-surface infrared heating to melt the powder. Selectivity of melting is achieved in the first process via application of an inhibitor, and in the second process via a mask. DE 103 11 438 describes another process. In this, the energy needed for melting is introduced via a microwave generator, and selectivity is achieved via application of a susceptor.

Other suitable processes are those which operate with an absorber, which is either present in the powder or is applied via inkjet methods, as described in DE 10 2004 012 682.8, DE 10 2004 012 683.6, and DE 10 2004 020 452.7.

The rapid prototyping or rapid manufacturing processes mentioned (RP or RM processes) can use pulverulent substrates, in particular polymers, preferably selected from polyester, polyvinyl chloride, polyacetal, polypropylene, polyethylene, polystyrene, polycarbonate, poly(N-methylmethacrylimides) (PMMI), polymethyl methacrylate (PMMA), ionomer, polyamide, or a mixture thereof.

WO 95/11006 describes a polymer powder suitable for laser sintering which exhibits no overlap of the melting and recrystallization peak when melting behavior is determined via differential scanning calorimetry at a scanning rate of from 10 to 20° C./min, and which has a degree of crystallinity of from 10 to 90%, likewise determined via DSC, and has a number-average molecular weight Mn of from 30 000 to 500 000, its Mw/Mn quotient being in the range from 1 to 5.

DE 197 47 309 describes the use of a nylon-12 powder with increased melting point and increased enthalpy of fusion, obtained via reprecipitation of a polyamide previously prepared via ring-opening and subsequent polycondensation of laurolactam. This is a nylon-12.

A disadvantage in all of the processes is that powders with relatively round grain shape have to be used. This restricts the selection of available materials. By way of example, it is disadvantageous to use material obtained via milling because the sharp edges of the particles give rise to poor powder-flow properties. This makes an automated construction process more difficult because application of the powder layers often produces grooves which in the worst case stop the construction process, but in all cases impair the quality of the resultant components, in particular density and surface quality.

The precipitation process described in DE19747309 also requires the solubility of the polymer in a solvent and capability for precipitation under suitable conditions. The methods described cannot convert amorphous polymers or copolymers into the form of a powder with round particles. The same restrictions apply to polymers which are insoluble or only sparingly soluble, e.g. PBT.

Other processes for production of round particles are restricted to a few materials for other reasons. An example which may be mentioned is anionic polymerization, which generates a poorly defined product and moreover does not permit addition of additives, such as stabilizers, before the end of the preparation process except where these do not disrupt the polymerization reaction.

There is another difficulty, in that additives such as flame retardants or impact modifiers have to be present in the powder. The amounts of these needed in the final product are usually above 1 percent by weight, in order to achieve the desired action; this generally prevents use of processes such as anionic polymerization or a precipitation process. If the two components are separately converted to powder form and then dry-blended, a disadvantage is that thorough mixing of the components is not achieved, and indeed no interactive effects can arise. By way of example, for impact modification it is advantageous for the impact-resistant component to couple to the base polymer. Another risk posed by a dry-blended mixture during processing by a rapid prototyping or rapid manufacturing process as described above is demixing of the two components, particularly if the nature of the particles differs greatly or their density differs markedly.

Nor does production of a compounded material and subsequent low-temperature milling lead to satisfactory results, for a number of specific reasons. Firstly, the compounding process itself can damage the polymers and also the additives. Secondly, low-temperature milling is, as a function of polymer or additive, a highly inefficient process, and commercialization of a powder produced by this method is therefore impossible. By way of example here, mention may be made of impact-modifying polymers in which the impact modifier leads to very low yield—irrespective of whether it has coupled to the polymer during the compounding process or not—values that may be mentioned by way of example being less than 30%. Other polymers that are very difficult to mill are polymers in the upper end of the molecular-weight range within their polymer class, but this is specifically advantageous for mechanical properties.

There have been many differing attempts to obtain powders with improved properties in particular for laser sintering. By way of example, DE 102 56 097 A1, WO 2004/050746 A1, and WO 2005/090448 A1 give proposals to that end. Inter alia, DE 102 56 097 A1 refers to EP 0 863 174, which is said to describe a process for production of a polyamide powder via precipitation from alcoholic solution, with the properties that are relevant to laser sintering and that can be achieved via a precipitation process.

EP 1 512 725 A1 discloses a dispersion of a resin component and of a water-soluble auxiliary component, and a production process for this dispersion, particular resin component proposed being a thermoplastic resin or a resin insoluble in water. As auxiliary component, an oligosaccharide, a saccharide, or sugar alcohols are proposed. The publication mentioned also discloses products produced using the dispersion, and in particular the production of highly porous material or of highly porous particles is described.

However, the process described in EP 1 512 725 A1, and the dispersion, are useful only for resin components which have a moderately high melting point. The process is not suitable for resins of higher melting point, because at temperatures higher than about 230° C. decomposition reactions in the oligosaccharide to be used as auxiliary component cause hardening of the mixture, which is then not dispersible.

### SUMMARY OF THE INVENTION

The object on which the present invention is based is therefore to provide a powder and a production process permitting wider application of processes for layer-by-layer moldless production of three-dimensional shaped articles, both in terms of the selection of the materials that can be used and in terms of cost-effectiveness.

The invention achieves this object via a process for production of a powder suitable for use in a process for the layer-by-layer moldless production of three-dimensional shaped articles, in which regions of the respective powder layer are selectively melted via input of electromagnetic energy, the production process comprising the mixing of a polymer or copolymer with at least one water-soluble polymeric polyol, the dissolution of the mixture in water to form a dispersion, the isolation of the polymer particles or copolymer particles from the dispersion, and the washing and drying of the isolated polymer particles or isolated copolymer particles, wherein the polymeric polyol is at least one been selected from the group consisting of polyethylene glycol and polyvinyl alcohol.

By virtue of the inventive process, it now becomes possible to process even high-melting-point polymers or copolymers at low cost to give a powder suitable for the shaping process mentioned, a particular example being relatively high-melting-point polyamides. The inventive process overcomes the restriction resulting from the process disclosed in EP 1 512 725 A1, due to decomposition of the auxiliary component, with respect to the processability of relatively high-melting-point polymers or copolymers.

Another advantage over the process disclosed in EP 1 512 725 A1 is that brownish discoloration of the powder due to reaction phenomena within the water-soluble auxiliary component is avoided. Finally, it has been found that the inventive process can achieve much less expensive treatment of the water-soluble auxiliary, and also allows final disposal to be more environmentally friendly and less expensive.

### DETAILED DESCRIPTION OF THE PREFERRED EMBODIMENTS

In one preferred embodiment, washing of the powder formed from the isolated polymer particles or isolated copolymer particles takes place until the powder formed from the polymer particles or copolymer particles has from 0.001% by weight to 5% by weight content of the polyol, based on the polymer particles or copolymer particles. Surprisingly, the inventors have found that a certain content of polyethylene glycol or polyvinyl alcohol in the finished powder is advantageous for the further use of the powder. This inventive embodiment of the process can substantially reduce the cost for the washing to extract the auxiliary, when comparison is made with the known process, and this firstly lowers production costs through shorter production times and secondly in particular leads to markedly lower water consumption.

In one preferred embodiment of the invention, it has been found to be advantageous that the isolated powder is mixed with a pulverulent filler, the filler content of the entire amount of the powder being up to 70% by volume. This method can establish certain mechanical properties of a shaped article produced from the powder.

It has also proven to be advantageous that the ratio by weight of the polymer or copolymer and of the at least one water-soluble polyol in the dispersion is from 1:99 to 91:9, preferably from 1:5 to 2:1.

The invention also achieves the object via a powder of the type mentioned at the outset, comprising a polymer powder or copolymer powder with from 0.001% by weight to 5% by weight content of a polymeric polyol, wherein the polymeric polyol is at least one been selected from the group consisting of polyethylene glycol and polyvinyl alcohol.

Surprisingly, the inventors have found that this content of polyethylene glycol and/or polyvinyl alcohol has particular attendant advantages with regard to the properties of the powder, although the prior art assumes that content of water-soluble components in the powder for processing, in particular in laser sintering, is disadvantageous and leads to disruption of the laser sintering process or to shortcomings in a shaped article produced thereby.

In fact, the inventors have found that by virtue of the content mentioned of polyols the powder has better overall powder-flow properties and therefore can be metered more reliably, even by automated methods. Furthermore, when comparison is made with a powder without this content, with comparable grain size distribution, the bulk density obtained is higher, and the porosity of a shaped article produced via laser sintering is therefore lower. This in turn leads to improved surface properties, and also to better mechanical properties of the shaped article produced therefrom. Another result of this content is that it is possible to eliminate dry powder-flow aids added in powders of the prior art, or to reduce the amount needed, these having a disadvantageous effect on processing latitude.

Furthermore, the inventors have found that the powder is also easier to reuse in the laser sintering application. In laser sintering or in any of the other processes mentioned at the outset for the layer-by-layer moldless production of three-dimensional shaped articles, this shaped article is formed within an uncompacted bed composed of the powder. During its production, the shaped article is supported via the surrounding powder which has not softened or has not been irradiated. Once the shaped article has been finished, it is removed from the powder bed. The remaining powder can in principle be reused for a subsequent operation. All that is then required is replacement of that portion of powder that has been lost via formation of the shaped article. However, the situation in practice is that the input of electromagnetic radiation into the powder bed also leads to interaction with the non-molten powder constituents processed to give the shaped article. The technical term for this is “ageing”. This “ageing” causes a shift in the processing latitude of the powder. The result of this is that the temperature range within which the polymer component or copolymer component of the powder begins to melt shifts or widens. The result is that in the regions which are intended to form the surface of the shaped article thermal induction involving powder which is actually not then intended to be melted prevents achievement of the clean and sharply delineated surfaces achieved when using fresh powder. The result is a reduction in the overall quality of a shaped article produced therewith. As a function of application sector, a certain proportion of fresh powder has to be used in order to obtain sufficient quality of the shaped article. The prior art terms this the “renewal factor”, cf. DE 102 56 097 A1. A high “renewal factor” means in practice that a considerable portion of a powder not yet involved in the construction process becomes unavailable for further use because of ageing, and has to be sent for disposal before it has been utilized. Because the inventive powder gives substantial reduction in ageing, loss of unutilized powder can be markedly reduced, and therefore cost-effectiveness can be markedly improved when producing a shaped article from this powder.

In order to establish certain mechanical properties of a shaped article to be produced from the inventive powder it is advantageous that the powder comprises a pulverulent filler, the filler content of the entire amount of the powder being up to 70% by volume.

It is advantageous that the median grain diameter of the powder is from 5 μm to 100 μm, preferably from 8 μm to 80 μm. This grain diameter gives particularly good processability for production of a shaped article via laser sintering.

It is advantageous that the BET surface area of the powder measured to DIN ISO 9277 is smaller than or equal to 10 m²/g, preferably smaller than or equal to 3 m²/g, particularly preferably smaller than or equal to 1 m²/g. This permits production of a shaped article with particularly few pores, and therefore high reliability with respect to achievement of certain strength values of a shaped article produced with this powder.

It is advantageous that the bulk density of the powder to DIN 53466 is from 300 g/l to 700 g/l. High bulk density of the powder permits high density of a shaped article produced therefrom, and therefore permits production of shaped articles which have particular mechanical stability.

It is advantageous that the d90:d10 grain size distribution of the powder is from 3:1 to 15:1, in particular for use in laser sintering.

It is moreover advantageous that the powder comprises powder-flow aids, if indeed there is any remaining need for these. The powder advantageously comprises inorganic particles as filler, particularly suitable materials for this purpose being glass particles, metal particles, or ceramic particles, e.g. glass beads, steel shot, or metal granules, for achievement of certain desired mechanical, electrical, or magnetic properties.

Organic and/or inorganic pigments can also be admixed, and in particular mention should be made here of titanium dioxide or carbon black. This can also affect the absorption behavior of the powder.

When the term “polyethylene glycol” is used in this application, the intention is that it means any of the forms of polyethylene glycol, irrespective of molar mass. In particular, the term “polyethylene glycol” is intended to describe not only those materials which are liquid under standard conditions but also higher-molecular-weight solid polyethylene glycols, which are occasionally also termed polyethylene oxides, and for which the abbreviation PEOX is used. The usual abbreviation for polyethylene glycol is PEG. According to ASTM, the abbreviation for the polyvinyl alcohols mentioned in this application is PVA, but these are otherwise abbreviated to PVAL.

It is advantageous that the molar mass of the polyethylene glycol is from 2000 to 2 000 000 g/mol, preferably from 7000 to 250 000 g/mol, particularly preferably from 9000 to 100 000 g/mol, in particular that the polyethylene glycol comprises a mixture composed of polyethylene glycols of different molar masses.

Furthermore, the inventors have found that the use of a mixture composed of polyethylene glycols of different molar masses can adjust melt viscosity, and have also found that this method can adjust the particle size of the powder produced, as a function of the polymer powder or copolymer powder used. This is particularly advantageous because it permits particularly cost-effective production of an inventive powder in the desired grain size with high yield.

In one particularly preferred embodiment of the inventive process and/or powder, the polymer or copolymer comprises a PEEK (polyether ketone), a PAEK (polyaryl ether ketone), a PSU (polysulfone), a PPSU (polyphenylene sulfone), a polyamide, or a mixture thereof. The polyamide comprises a relatively high-melting-point polyamide, a PA1010, a PA610, a PA6, a PA66, a PA46, an aliphatic or aromatic polyester, an aliphatic, cycloaliphatic, or aromatic polyamide, a copolyamide, a mixture thereof.

In economic terms, it is particularly useful that the invention provides the use of an inventive powder in a process for the layer-by-layer moldless production of three-dimensional shaped articles, in which regions of the respective powder layer are selectively melted via input of electromagnetic energy, and provides a shaped article thus produced. This shaped article can have from 0.0005% by weight to 5% by weight content of polyol.

### EXAMPLES

Some examples will be used below for further explanation of the invention. The inventive production process, the inventive powder, and its inventive use are described below, but there is no intention that the invention be restricted to that description. The term polymer here includes copolymers.

An advantage of the use of polymer powder produced from a dispersion is that shaped articles produced therefrom via a layer-by-layer process in which regions of the respective layer are selectively melted can be formed using polymers or, respectively, copolymers which have not hitherto been processable in the processes explained in the prior art. This can provide access to properties quite different from those possible hitherto. By way of example, copolymers or amorphous polymers can now be used in the processes described, for achievement of transparency or impact resistance in the shaped articles. This applies in particular to those polymers and copolymers whose melting point is higher than typically 230° C.

Alongside the polymers mentioned as particularly preferred according to the invention, it is also possible to use another polymer insoluble in water, or a thermoplastic polymer, or a thermoset, or else a combination thereof. Examples of the thermoplastic polymer are polycondensates, such as polyesters, aliphatic or aromatic, polyamides, copolyamides, polyarethanes, poly(thio)ethers, polycarbonate, polysulfone, polyimide, and also polymers such as polyolefins, methacrylates, polystyrene, vinyl-based polymers, and products derived from naturally occurring substances, e.g. cellulose derivatives. Mention may also be made of copolymers. An example of the thermoset is provided by epoxy resins, unsaturated polyesters, diallyl phthalates, and silicones. Particular mention may be made of thermoplastic elastomers, for example those based on polyamide, on polyester, on polyvinyl chloride, or on fluoropolymers. Mention may likewise be made of polyvinyl chloride, polyacetal, polypropyliene, polyethylene, polystymene, polycarbonate, polybutylene terephthalate, polyethylene terephthalate, polysulfone, polyarylene ether, polyurethane, polylactides, polyoxyalkylenes, poly(N-methylmethacrylimides) (PMMI), polymethyl methacrylate (PMMA), ionomer, silicone polymers, terpolymers, acrylonitrile-butadiene-styrene copolymers (ABS), and mixtures thereof.

Preferable soluble auxiliary component used is a water-soluble matrix material incompatible with the polymer, e.g. a polyethylene glycol or a polyvinyl alcohol. PEG has very good water-solubility and a dispersion therewith can therefore be produced easily and at low cost and the PEG can easily be extracted by washing with little pollution of the environment. Another possibility would be the use of an auxiliary component soluble in organic solvents, in particular in combination with a polyamide as polymer. However, the use of organic solvents has various disadvantages with regard to environmental pollution and disposal costs.

If necessary, the dispersion can comprise other additives. By way of example, mention may be made of fillers, stabilizers, thickeners, colors (pigments), lubricants, dispersing agents, antistatic agents, or flame-retardant additives. The fillers can be mica, clay, talc or else rayon fibers, but there is no intention that the invention be restricted thereto. Particularly mention may be made of glass beads or glass fibers, carbon fibers, including ground fibers, and metal particles.

The dispersion can be prepared by kneading the polymer component with the auxiliary component. The kneading process can be carried out in a conventional kneader (e.g. in a single or twin-screw extruder, or in a kneader, or on a calender). Before that process begins, it can be advantageous to invert the polymer component and/or the auxiliary component into a powder-like form via low-temperature grinding or preliminary kneading. The kneading or forming temperature is preferably from 90 to 400° C., particularly preferably from 110 to 260° C., and very particularly preferably above 140° C. Unlike in the prior art, the restriction in the region of 230° C. which arises with oligosaccharide in order to avoid thermal decomposition of the auxiliary component is not applicable in the present invention.

The disperse system (a form in which the polymer component and the auxiliary component are present in disperse form) can be produced via cooling of a molten mixture (for example from the kneader), the molten mixture comprising the polymer component and the auxiliary component. The cooling temperature should be at least 10° C. below the heat distortion temperature of the polymer component, or below the melting or softening point of the auxiliary component.

The cooling time is matched to the polymer component and the auxiliary component, and another relevant factor is the cooling temperature; by way of example, the cooling time can be within a wide range of from 30 seconds to 20 hours. Preferred times are from 1.5 to 30 minutes, for example.

Particularly in instances in which the polymer component and the auxiliary component are mutually compatible, the disperse system can be obtained by utilizing different circumstances with respect to surface tension and hardening, for example via crystallization, in order to develop the disperse system during the cooling process.

The average pore size and, respectively, the particle size of a particle can be influenced via balancing of compatibility between polymer component and auxiliary component, via the viscosity difference between the components, via the kneading or forming conditions, and also the cooling conditions, thus giving a wide range for adjustment of pore size and pore distribution and of particle size and particle size distribution.

The disperse system is combined with a solution in order to separate the auxiliary component from the polymer component, or extract it by washing. The preferred solvent is water, which is inexpensive and environmentally friendly. The auxiliary component can be removed under ambient pressure, or under increased pressure, or in vacuo. The temperature during removal of the auxiliary component depends on the components and is by way of example from 10 to 100° C.

The particles are collected via filtration or centrifugal force, for example. The polyethylene glycol content advantageously obtained in the powder isolated and dried is in the range from 0.001% by weight to 5% by weight, based on the polymer particles or copolymer particles.

The particles produced via removal of the auxiliary component form a powder whose shape is preferably round.

In order to produce particles with an inventive median grain diameter, operations preferably use the ratio by weight of from 1:99 to 91:9 between the polymer component and the water-soluble auxiliary component. If appropriate, precautionary sieving and further classification of the resultant powder follow. Advantages can also be provided by post-treatment in a high-speed mixer for further rounding of the particles. With the inventive powder, there is little need for addition of a separate powder-flow aid of the prior art.

The person skilled in the art can easily use exploratory preliminary experiments to find the conditions for processing in the inventive powder-based moldless production process.

The BET surface area of the powder produced from the dispersion is smaller than 10 m²/g, preferably smaller than 3 m²/g, and particularly preferably smaller than 1 m²/g. The d50 median grain diameter is preferably from 5 μm to 100 μm, particularly preferably from 8 μm to 80 μm.

The viscosity of the polymer has to be judged in such a way as to permit good processing in the inventive process. A material of rather low viscosity therefore generally has better suitability; molecular weights such as those conventional for the respective polymer in injection molding are preferable to materials optimized for the extrusion process. The molecular weight of the starting material can alter during conversion into a pulverulent form with the aid of the process described above; upward deviations and also downward deviations have been found in the experiments here.

The grain size distribution of the resultant powder is relatively broad; D90:D10 is from 3:1 to 15:1, preferably from 4:1 to 10:1, but it can also be narrow or bimodal. The bulk density of the inventive powders is preferably in the range from 300 to 700 g/l. The BET surface area can be determined via gas adsorption using the Brunauer, Emmet and Teller principle; the standard utilized is DIN ISO 9277.

Inventive powders for use in an inventive process can moreover comprise auxiliaries and/or fillers and/or other organic or inorganic pigments. By way of example, these fillers can be glass particles, metal particles, or ceramic particles, e.g. glass beads, steel shot, or metal granules, or foreign pigments, e.g. transition metal oxides. By way of example, the pigments can be titanium dioxide particles based on rutile (preferably) or anatase, or carbon black particles. Mention should also be made here of addition of absorbers which can give easier processing in the inventive process. Addition of carbon black has proven to be particularly advantageous.

The median size of these filler particles is preferably smaller than or approximately equal to the size of the particles of the polymer powder. The median particle size d50 of the fillers should preferably be not more than 20% above, preferably not more than 15% above, and with very particular preference not more than 5% above, the median particle size d50 of the polymer powder. A particular limit on particle size is given by the permissible overall height or, respectively, layer thickness in the rapid prototyping/rapid manufacturing system.

It is also possible to mix conventional polymer powders with polymer powders produced in a dispersion as described above. This method can produce polymer powders with a further combination of surface properties. By way of example, the process for production of these mixtures can be found in DE 34 41 708. In a particularly advantageous method here, the polymer powder produced by means of dispersion and having rather round particle shape is mixed with a polymer powder obtained via low-temperature milling, the particles of which have markedly sharper edges. The polymer powder produced via the dispersion acts here as a powder-flow aid, in such a way that the processing difficulties associated with the ground powder can be eliminated via the use of this mixture. Advantageous mixtures comprise at least 30% of polymer powder produced from a dispersion as described above, and particularly advantageous mixtures comprise at least 40% thereof, and very particularly advantageous mixtures comprise at least 50% of a polymer powder of that type.

Inorganic foreign pigments, e.g. transition metal oxides, stabilizers, e.g. phenols, in particular sterically hindered phenols, and also filler particles can be added to the polymer powder, to improve processability, or for its further modification.

The present invention also provides the use of an inventive powder in a process for production of shaped articles via layer-by-layer processes in which regions of the respective layer are selectively melted, using inventive powders. The energy here is introduced via electromagnetic radiation, and selectivity is introduced by way of example via masks, application of inhibitors, of absorbers, or of susceptors, or else via focusing of the radiation, for example via a laser. The electromagnetic radiation comprises the range from 100 nm to 10 cm, preferably from 400 nm to 10 600 nm, or from 800 to 1060 nm. By way of example, the radiation source can be a microwave generator, a suitable laser, a radiant heater, or a lamp, or else a combination thereof. Once all of the layers have cooled, the inventive shaped article can be removed.

The examples below of these processes serve for explanation, but there is no intention that the invention be restricted thereto. Laser sintering processes are well known and are based on the selective sintering of polymer particles, layers of polymer particles being briefly exposed to a laser light, and the polymer particles exposed to the laser light thus being bonded to one another. Successive sintering of layers of polymer particles produces three-dimensional objects. Details of the selective laser sintering process are found by way of example in the specifications U.S. Pat. No. 6,136,948 and WO 96/06881.

SIB processes described in WO 01/38061, or a process as described in EP 1 015 214, are other processes with good suitability. Both processes operate with full-surface infrared heating to melt the powder. Selectivity of melting is achieved in the first process via application of an inhibitor, and in the second process via a mask. DE 103 11 438 describes another process. In this, the energy needed for melting is introduced via a microwave generator, and selectivity is achieved via application of a susceptor.

Other suitable processes are those which operate with an absorber, which is either present in the powder or is applied by an inkjet process, as described in DE 10 2004 012 682, DE 10 2004 012 683 and DE 10 2004 020 452.

There are application sectors for inventive shaped articles not only in rapid prototyping but also rapid manufacturing. The latter particularly means short runs, i.e. production of more than one identical part, where, however, production by means of an injection mold would be uneconomic, and especially where the shape of the parts is very complex. Examples here are parts for high-specification cars, racing cars, or rally cars, only small numbers of which are produced, or replacement parts for motor sports, where the important factor is not only the small numbers but also the availability time. Industries that can use the inventive parts are the aerospace industry, medical technology, mechanical engineering, automobile construction, the sports industry, the household goods industry, the electrical industry, and the lifestyle industry.

Melting points can be determined by means of DSC (differential scanning calorimetry) to DIN 53765, or to AN-SAA 0663. Solution viscosity can be determined to DIN EN ISO 307 in 0.5% strength solution in m-cresol. Bulk density is to be determined using an apparatus to DIN 53 466.

The examples and experimental results below illustrate the advantages of the invention.

Various polyamide molding compositions as in Table 1 were used as polymer component or copolymer component for the examples and experiments.

TABLE 1

| Material | Melting point (° C.) | Relative solution viscosity |
|---|---|---|
| VA Z | 178 | 1.6 |
| VA E | 150 | 1.9 |
| TG CX | 250 | 1.9 |

VA Z here indicates a low-viscosity polymer based on PA12. This polymer based on PA12 is commercially available from DEGUSSA AG, Marl, Germany, as Vestamid L1600. The ISO 1874-1 name is: PA12, XN, 12-010. VA E indicates a PA12 elastomer commercially available from DEGUSSA AG, Marl, Germany, as Vestamid E40. The material termed TG CX is a medium-viscosity polyamide suitable for optical applications, available from DEGUSSA AG, Marl, Germany, as Trogamid CX7323. Vestamid and Trogamid are registered trademarks of DEGUSSA AG.

Water-soluble polyethylene glycols as in Table 2 and mixtures of the polyethylene glycols mentioned were used as auxiliary component.

TABLE 2

| Material | Mn | Viscosity (Pas) | Melting point (° C.) |
|---|---|---|---|
| PEG 20M | 20000 | 3 | 65 |
| PEG LE | 65000 | 430 | 74 |
| PEG R150 | 43000 | 180 | 65 |

PEG 20M indicates a polyethylene glycol commercially available from NOF Corporation, Japan, and the polyethylene glycols termed PEG LE and PEG R150 are commercially available from Meisei Chemical Works, Ltd, Japan.

Polymer component and auxiliary component were mixed and were kneaded in an extruder. The extruder used comprised a JSW TEX30-SST twin-screw extruder whose screw diameter was 30 mm. Temperature conditions, screw rotation rate, and mass flow throughput are found in Table 3.

TABLE 3

| | Temperature (° C.) | | | Resin | Screw | Mass |
|---|---|---|---|---|---|---|
| | Feed | Mixing | | temp. | rotation rate | flow |
| Material | zone | zone | Die | (° C.) | (rpm) | (kg/h) |
| VA Z | 50 | 190 | 190 | 192 | 239 | 7 |
| VA E | 50 | 190 | 190 | 193 | 239 | 7 |
| TG CX | 50 | 270 | 270 | 278 | 239 | 7 |

The extrudate kneaded in the extruder was cooled after discharge from the extruder and dispersed in water. The concentration of the dispersion was 10%. This gave a mixture composed of PEG solution and of dispersed powder. This dispersion was filtered, and the powder isolated by filtration washed repeatedly with water in order to remove most of the PEG. The washed powder was dried using a vibration dryer at 80° C. for a period of 6 hours, and classified in a classifier.

Table 4 gives the mixtures used and the median grain size of the resultant powder. The constituents of each mixture are given in parts by weight.

TABLE 4

| Material | Matrix | | | | Grain size |
|---|---|---|---|---|---|
| (PA) | PEG LE | PEG 20M | PEG R150 | PA | (μm) |
| VA Z | 10 | 90 | | 50 | 25 |
| VA Z | 5 | 95 | | 50 | 33 |
| VA Z | | 100 | | 50 | 31 |
| VA Z | | 90 | 10 | 50 | 8.6 |
| VA Z | 10 | 90 | | 60 | 21 |
| VA Z | 10 | 90 | | 90 | 17 |
| VA E | 10 | 90 | | 50 | 13 |
| TG CX | 20 | 80 | | 50 | 60 |
| TG CX | 30 | 70 | | 50 | 30 |
| TG CX | 50 | 50 | | 50 | 15 |
| TG CX | 30 | 70 | | 60 | 28 |

In the case of the mixture given in line nine of Table 4, the bulk density measured for the resultant powder was 464 g/l.

The data in Table 4 show the excellent results of the inventive production process and the particular suitability of the powders obtained for the laser sintering process. It can also be seen that the inventive process can process low and high-melting-point polymers, in particular polyamides, to give inventive powders. The same applies to polyamides of varying relative solution viscosity.

Finally, the data provide very impressive evidence that mixing of PEGs of varying molar masses, and in particular adjustment of the mixing ratio of PEGs of varying molar masses, and of the polymer component or copolymer component, can provide very precise control of the median grain size of the resultant polymer powder, and can control this practically over the entire grain size range advantageous for the laser sintering process.

Furthermore, experiments have shown that a certain content of PEG in the finished polymer powder has advantageous attendant effects for the use in the laser sintering of shaped articles, and that, in contrast to opinion held hitherto, the auxiliary component does not necessarily have to be removed from the powder so as to leave minimum residue. There is moreover no risk of brownish discoloration of the powder caused by undesired thermally initiated reactions of the auxiliary component, e.g. as is observed in the known use of an oligosaccharide as constituent of the auxiliary component.

The abovementioned advantages of the invention, and those mentioned at an earlier stage above, permit a marked broadening, in terms of materials, of the range of application of the known processes for layer-by-layer moldless production of three-dimensional shaped articles. Furthermore, the inventive production process provides marked economic improvement. In particular together with the advantageous properties of the inventive powder it is possible to broaden substantially the application sector for the shaping processes, in particular for the laser sintering process, to include less expensive shaped articles or, respectively, products, in particular also for short production runs.

The entire description of German priority application DE 10 2006 015 791.5, filed Apr. 1, 2006, is hereby incorporated by reference.

1. A process for production of a powder comprising mixing at least one polymer or copolymer with at least one water-soluble polymeric polyol to form a mixture, dissolving the mixture in water to form a dispersion, isolating polymer particles containing the polymeric polyol or copolymer particles containing the polymeric polyol from the dispersion, and washing and drying the isolated particles thereby forming a powder, wherein the polymeric polyol is at least one selected from the group consisting of polyethylene glycols and polyvinyl alcohols, and wherein the powder is capable of undergoing a layer-by-layer moldless production to form a three-dimensional shaped article by selectively melting via input of electromagnetic energy regions of respective powder layers formed from said powder.

2. A process according to claim 1, wherein the washing is carried out until the powder has from 0.001% by weight to 5% by weight content of the polyol, based on the polymer particles or copolymer particles.

3. A process according to claim 1, wherein the powder is mixed with a pulverulent filler, the filler content of the entire amount of the powder being up to 70% by volume.

4. A process according to claim 1, wherein the ratio by weight of the polymer or copolymer and of the at least one water-soluble polymeric polyol in the dispersion is from 1:99 to 91:9.

5. A process according to claim 4, wherein the ratio by weight of the polymer or copolymer and of the at least one water-soluble polymeric polyol in the dispersion is from 1:5 to 2:1.

6. A process according to claim 1, wherein the polymeric polyol comprises polyethylene glycol having a molar mass of from 2000 to 2 000 000 g/mol.

7. A process according to claim 6, wherein the molar mass of the polyethylene glycol is from 7000 to 250 000 g/mol.

8. A process according to claim 6, wherein the molar mass of the polyethylene glycol is from 9000 to 100 000 g/mol.

9. A process according to claim 1, wherein the polymeric polyol comprises a mixture composed of polyethylene glycols of different molar masses.

10. A process according to claim 1, wherein the polymer or copolymer comprises a polyether ketone, a polyaryl ether ketone, a polysulfone, a polyphenylene sulfone, a polyamide, an aliphatic or aromatic polyester, an aliphatic, cycloaliphatic, or aromatic polyamide, a copolyamide, or a mixture thereof.

11. A process according to claim 10, wherein the polymer or copolymer is a polyamide, which comprises a polyamide having a melting point of at least 230° C., a PA1010, a PA610, a PA6, a PA66, a PA46, or a mixture thereof.

12. A powder comprising at least one polymer or copolymer and from 0.001% by weight to 5% by weight, based on the polymer or copolymer, of at least one polymeric polyol selected from the group consisting of polyethylene glycols and polyvinyl alcohols, wherein the powder is capable of undergoing a layer-by-layer moldless production to form a three-dimensional shaped article by selectively melting via input of electromagnetic energy regions of respective powder layers formed from said powder.

13. A powder according to claim 12, wherein the powder comprises at least a pulverulent filler, the filler content of the entire amount of the powder being up to 70% by volume.

14. A powder according to claim 12, wherein the median grain diameter of the powder is from 5 to 100 μm.

15. A powder according to claim 14, wherein the median grain diameter of the powder is from 8 to 80 μm.

16. A powder according to claim 12, wherein the BET surface area of the powder to DIN ISO 9277 is smaller than or equal to 10 m²/g.

17. A powder according to claim 16, wherein the BET surface area of the powder to DIN ISO 9277 is smaller than or equal to 3 m²/g.

18. A powder according to claim 16, wherein the BET surface area of the powder to DIN ISO 9277 is smaller than or equal to 1 m²/g.

19. A powder according to claim 12, wherein the bulk density of the powder to DIN 53466 is from 300 to 700 g/l.

20. A powder according to claim 12, wherein the d90 to d10 grain size distribution of the powder is from 3:1 to 15:1.

21. A powder according to claim 12, wherein the powder comprises a powder-flow aid.

22. A powder according to claim 12, wherein the powder comprises inorganic particles as filler.

23. A powder according to claim 12, wherein the powder comprises organic and/or inorganic pigments.

24. A powder according to claim 12, wherein the powder comprises carbon black and/or titanium dioxide.

25. A powder according to claim 12, wherein the polymeric polyol comprises polyethylene glycol having a molar mass of from 2000 to 2 000 000 g/mol.

26. A powder according to claim 25, wherein the molar mass of the polyethylene glycol is from 7000 to 250 000 g/mol.

27. A powder according to claim 25, wherein the molar mass of the polyethylene glycol is from 9000 to 100 000 g/mol.

28. A powder according to claim 12, wherein the polymeric polyol comprises a mixture composed of polyethylene glycols of different molar masses.

29. A powder according to claim 12, wherein the polymer or copolymer comprises a polyether ketone, a polyaryl ether ketone, a polysulfone, a polyphenylene sulfone, a polyamide, an aliphatic or aromatic polyester, an aliphatic, cycloaliphatic, or aromatic polyamide, a copolyamide, or a mixture thereof.

30. A powder according to claim 29, wherein the polymer or copolymer is a polyamide, which comprises a polyamide having a melting point of at least 230° C., a PA1010, a PA610, a PA6, a PA66, a PA46, or a mixture thereof.

31. A powder obtainable by the process according to claim 1.

32. A method for the layer-by-layer moldless production of a three-dimensional shaped article, comprising selectively melting via input of electromagnetic energy regions of respective powder layers formed from the powder according to claim 31.

33. A method for the layer-by-layer moldless production of a three-dimensional shaped article, comprising selectively melting via input of electromagnetic energy regions of respective powder layers formed from the powder according to claim 12.

34. A shaped article obtained by the method according to claim 32.

35. A shaped article obtained by the method according to claim 33.

36. A shaped article according to claim 34, wherein the shaped article has from 0.0005% by weight to 5% by weight content of the polyol.

37. A shaped article according to claim 35, wherein the shaped article has from 0.0005% by weight to 5% by weight content of the polyol.
